(19) United States
(12) Patent Application Publication
(10) Pub. No.: US 2008/0278564 A1
(43) Pub. Date: Nov. 13, 2008

(54) Record Carrier and Method of Recording an Image

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,994

(22) PCT Filed: Apr. 14, 2005
(86) PCT No.: PCT/IB05/51221

§ 371 Date: Oct. 17, 2006

(30) Foreign Application Priority Data
Apr. 20, 2004 (EP) 04101630.4

(51) Int. Cl. B41J 2/435; B32B 3/10; B32B 3/30; B32B 3/24

(52) U.S. Cl. 347/232; 428/195.1; 428/167; 428/138

(57) ABSTRACT

A record carrier (10) and a method of recording an image on a record carrier (10) are provided. On top of a colored pixel pattern layer (14) a mask layer (18) is arranged, the optical transparency of which can be changed by applying heat by a laser beam (24). In order to protect the colored pixel pattern layer (14) against the heat applied by the laser beam (24), a thermal barrier layer (16) is provided between the colored pixel pattern layer (14) and the mask layer.

### FIELD OF THE INVENTION

The present invention relates to a record carrier and to a method of writing an image on a record carrier. Particularly, the present invention is directed to the recording of an image on a record carrier within an optical recorder by using a laser that is a part of the optical recorder.

### BACKGROUND OF THE INVENTION

In many applications, it is advantageous to write a label on an optical record carrier. In the prior art several approaches have been suggested. For example, an optical disk can simply be marked by hand with a pen or a marker. Another possibility is to use an adhesive label that can be fixed to the disk. More elaborate techniques have been proposed that use the same optical unit within an optical recorder as is used for writing and/or reading the data. Several possibilities have been suggested to write the label on the same side as the data, for example in the remaining unwritten part of the disk, via structured writing of redundant data blocks such that visible patterns result. The drawback of this technique is the poor visible optical contrast and the fact that only a monochromic image can be the result of such a writing process.

A further technique has been proposed in US 2003/0161224 A1. Colored regions are arranged in a pattern, arid a thermally-sensitive layer is arranged on top of the pattern. Areas of the thermally-sensitive layer can be selectively burned to either reveal or hide particular colored regions. Since it is desirable to use a thermally-sensitive layer that is stable at room temperature, a considerable amount of heat will be lodged in the layered system in order to achieve the desired change of transparency in the thermally-sensitive layer. This might lead to problems, since the colored pixel pattern, for example made from organic dyes, will be degraded due to the thermal energy.

An object of the present invention is to provide a record carrier and a method of recording an image of high quality using a laser beam, so that problems with excessive heat applied by the laser beam are avoided.

### SUMMARY OF THE INVENTION

The above objects are solved by the features of the independent claims. Further developments and preferred embodiments of the invention are outlined in the dependent claims.

In accordance with the present invention, there is provided a record carrier having a plurality of stacked layers comprising at least one colored pixel pattern layer and at least one mask layer on top of at least a region of the colored pixel pattern layer, the optical transparency of a region of the mask layer changing by applying heat by a laser beam to the region of the mask layer, characterized in that at least one thermal barrier layer is provided between the colored pixel pattern layer and the mask layer. The colored pixel pattern layer can be created for example by ink-jet printing, micro-contact printing or any other suitable deposition technique that can achieve the required spatial resolution. In an initial state, the mask layer is, for example, white and non-transparent. Laser induced heating by application of the laser pulse causes the formation of a transparent region. In this way, a colored region becomes visible underneath the mask layer. For example, the colored pixel pattern layer comprises a pattern of the colors red, green and blue. What finally appears as a pixel in the recorded image is a composition of a red, green and blue sub-pixel. The amount of exposure of each color per visible pixel, in fact the area of each sub-pixel, determines the final color of the visible pixel. Therefore, intensity variation and color sensation is enabled by the on-forehand determined area ratio of the sub-pixels. The thermal barrier layer protects the colored pixel pattern layer when heat is applied to the mask layer. The transparency change of the mask layer is not necessarily, as described above, an increasing transparency; images can also be written on a transparent mask layer by decreasing the transparency upon the application of laser pulses.

In a preferred embodiment the plurality of stacked layers comprises a substrate on top of which the colored pixel pattern layer, the thermal barrier layer and the mask layer are arranged, and wherein the substrate comprises grooves for tracking purposes. For tracking purposes groove-only substrates can be employed, similar as those used in optical write-once data carriers.

It can be advantageous that the colored pixels are at least partly aligned with the grooves. For example, the record carrier comprises (a) 500 red grooves, then (b) 500 blue grooves and then (c) 500 green grooves, etc. An in-situ calibration of the relative location of the recording grooves with respect to the pixel location will be performed. In this context it is preferred that calibration apertures are provided in the mask layer. In the area of the calibration apertures, the reflection of the sub-pixels can be measured that are sufficiently different to distinguish them. The sub-pixels are then appointed to the grooves via addresses present in the grooves. Another possibility is to write the pixels in a meandering coordinate system as a reference for alignment.

According to a preferred embodiment the sequence of layers is (a) substrate, (b) colored pixel pattern layer, (c) thermal barrier layer, and (d) mask layer. In this case, the recording stack should have sufficient reflectivity to enable focusing and tracking of the laser spot. It is possible to arrange a transparent cover layer on top of the mask layer, the thickness of which is preferably tuned to the optical system, i.e., in case of e.g. DVD, to 0.6 mm.

Another possibility is to provide a record carrier wherein the sequence of layers is (a) substrate, (b) mask layer, (c) thermal barrier layer, and (d) colored pixel pattern layer. In this case the preferably pre-grooved substrate has a thickness of for example 0.6 mm. Thereby, the substrate is tuned to the system optics of a DVD recorder. In the case of the application of the present invention in different embodiments, the thickness of the substrate can be appropriately chosen, for example to 1.2 mm in the case of a CD recorder. With respect to the present embodiment based on the mentioned sequence of layers, it is preferable to provide a thermal protection layer between the substrate and the mask layer in order to protect the substrate against excessive heat.

According to the preferred embodiment, the thermal barrier layer comprises a material from the group of ZnS-SiO₂, SiC, Si₃N₄, Al₂O₃. These materials are able to protect the colored pixel layer against the recording temperature.

It is preferred that the mask layer comprises a thermo-chromic material. For example, the mask layer comprises a material from the group of AgO and poly(3,4-ethylenedioxythiophene). The latter material, also known as PEDOT, is a conjugated polymer and is has good thermal and chemical stability. The polymers are dispersible in water and they can be spin-coated on a disk.

Another example is that the mask layer comprises organic dyes. Such organic dyes are able to bleach upon temperature-induced degradation, i.e. the color changes preferably to a transparent state.

A further possibility is that the mask layer comprises a material that undergoes a phase transition upon heating. Such a laser heating induced phase transition is, for example, a transition from the non-transparent amorphous phase to the transparent crystalline phase.

A still further possibility is that the mask layer comprises a dual layer system that mixes upon heating, thereby changing the transparency. For example the Bi-Si system is a possible dual-layer system. In the initial unmixed state, the two layers are non-transparent, but after mixing due to laser induced heating, the alloy is transparent.

In accordance with the present invention, there is further provided a method of recording an image on a record carrier, the record carrier having a plurality of stacked layers comprising at least one colored pixel pattern layer and at least one mask layer on top of at least a region of the colored pixel pattern layer, the optical transparency of a region of the mask layer changing by applying heat by a laser beam to the region of the mask layer, characterized in that at least one thermal barrier layer is provided between the colored pixel pattern layer and the mask layer. Thus, the advantages and particularities of the record carrier according to the present invention are also realized in relation to a method. This is also applicable with relation to the preferred embodiments of the record carrier that can be translated into preferred embodiments of the method according to the invention.

According to a preferred embodiment of the method according to the invention, a defocused laser beam provided in an optical recorder is used. The alignment of the optical spot with the colored pixel pattern is important. The requested image resolution is much lower than the resolution of the diffracted laser spot of an ordinary optical system. The pixel size is for instance 20 μm×20 μm=400 μm². For CD-kind optics, the laser spot area is approximately 1 μm², for DVD-kind optics, the spot area is approximately 0.25 μm². Therefore, using a focussed laser beam, at least 400-2000 write actions are needed to write an aperture of the size of an image pixel. This number of write actions is reduced by reducing the pixel size. According to the presently discussed preferred embodiment it is possible to enlarge the laser spot by defocusing or by using a different cover layer thickness. In that case, less write actions are sufficient. However, a higher laser power is needed, given a particular mask layer material.

In accordance with the present invention, there is further provided an optical recorder for recording an image on a record carrier according to the present invention. Thus, the advantages and particularities of the record carrier according to the present invention are also realized in relation to an optical recorder. This is also applicable with relation to the preferred embodiments of the record carrier that can be translated into preferred embodiments of the optical recorder according to the invention.

These and other aspects of the invention will be apparent from and elucidated with reference to the embodiments described hereinafter.

### BRIEF DESCRIPTION OF THE DRAWINGS

FIG. 1 shows a schematic drawing of an optical recorder according to the invention;

FIG. 2 shows a schematic drawing of a record carrier according to the present invention;

FIG. 3 shows a schematic drawing of a colored pixel pattern;

FIG. 4 shows an example of a monochromic image written on a record carrier according to the present invention; and

FIG. 5 shows a flow chart illustrating a preferred embodiment of a method according to the present invention.

### DESCRIPTION OF PREFERRED EMBODIMENTS

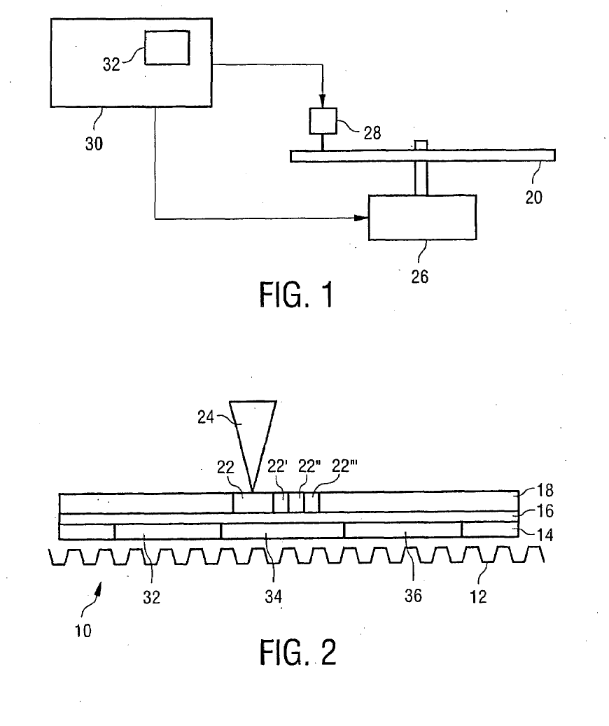

FIG. 1 shows a schematic drawing of an optical recorder according to the invention. Only components that are directly related to the present invention are shown in the schematic drawing. An optical disk 20 is arranged on a motor 26 of the optical recorder. A laser 28 is arranged so that a laser beam from the laser 28 can reach the optical disk 20. A controller 30 is provided in order to position the laser 28 so that the laser beam can reach a particular position on the optical disk 20. This is achieved by for example a translational movement of the laser 28 and a rotational movement of the disk 20 by means of the motor 26. The positioning of the laser 28 is supported by a tracking system that can be similar to tracking systems of prior art that are used for reading and/or writing with respect to an optical storage medium. The controller 30 further comprises a memory 32 in which data are stored on basis of which an image is recorded on the optical disk 20.

The laser beam from the laser 28 is directed to the back of the optical disk 20. In this sense, the laser 28 can be a particular laser dedicated for recording the image on the optical disk 20. Another possibility is to provide a turning mechanism in order to turn the disk from a data recording/reading position (not shown in FIG. 1) into an image recording position (shown in FIG. 1). Another possibility is to manually turn the disk in order to practice the present invention.

The memory 32 containing the image data is not necessarily a part of the controller 30. For example, the memory can be an external memory. Another possibility is that data from the optical disk 20 contain the image information, so that, after reading these data, the image can be recorded on the back of the disk 20.

FIG. 2 shows a schematic drawing of a record carrier according to the present invention. The record carrier 10 comprises four stacked layers 12, 14, 16, 18. For example, these layers are formed on the back of the optical disk 20 from FIG. 1, covering at least part of its surface. The lower layer is a grooved substrate 12, wherein the grooves are provided for tracking purposes. The next layer 14 is a colored pixel pattern layer. For example the region 32 forms a red pixel, the region 34 forms a green pixel, and the region 36 forms a blue pixel. On top of the colored pixel pattern layer 14, a thermal barrier layer 16 is provided. On top of the thermal barrier layer 16, a mask layer 18 is arranged. Onto this mask layer 18, a laser beam 24 is directed in order to change the transparency of the mask layer 18. For example, the mask layer 18 is initially non-transparent, then the laser beam 24 creates an aperture 22 into the mask layer 18. Several apertures 22, 22′, 22″, 22′″ are shown in the drawing. On the basis of an appropriate selection of the size of the apertures 22, 22′, 22″, 22′″, the amount of exposure of each color per pixel on the record carrier that acts as a reflective display can be determined. Thereby the final color of the pixel is selected. Preferably, the mentioned stack is covered with a protection coating (not shown in the drawing). The protection coating can be optimized with respect to the preferred optical spot for writing apertures in the mask layer. The protection coating has a thickness between preferably 1 and 100 μm.

The embodiment according to FIG. 2 can be altered by providing the grooved substrate on top of the mask layer 18. In this case, it is preferred to choose the thickness of the grooved substrate 12 in accordance with the optics of the system, particularly, when an optical recorder with given optical properties is employed.

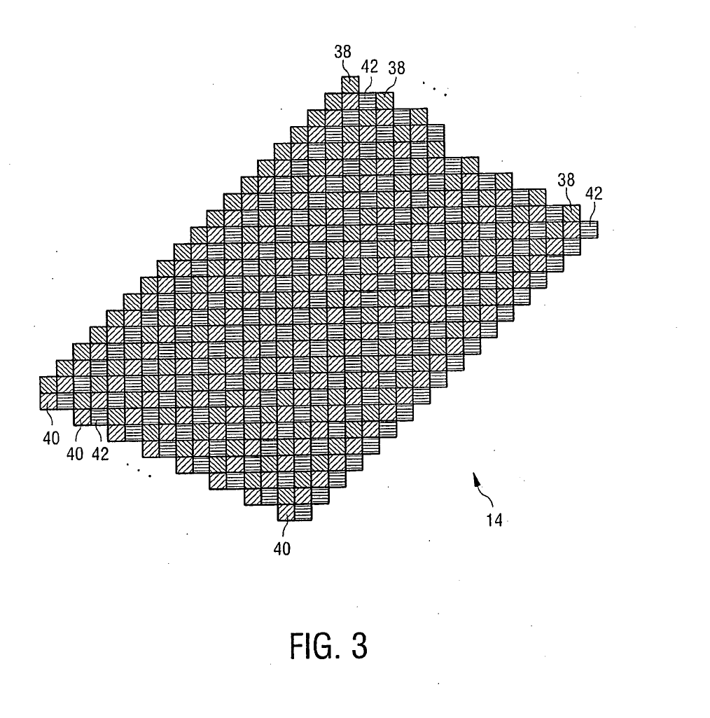

FIG. 3 shows a schematic drawing of a colored pixel pattern. In this example, the pixels of different colors are arranged in rows. For example, the rows 38 represent red pixels, the rows 40 represent green pixels, and the rows 42 represent blue pixels.

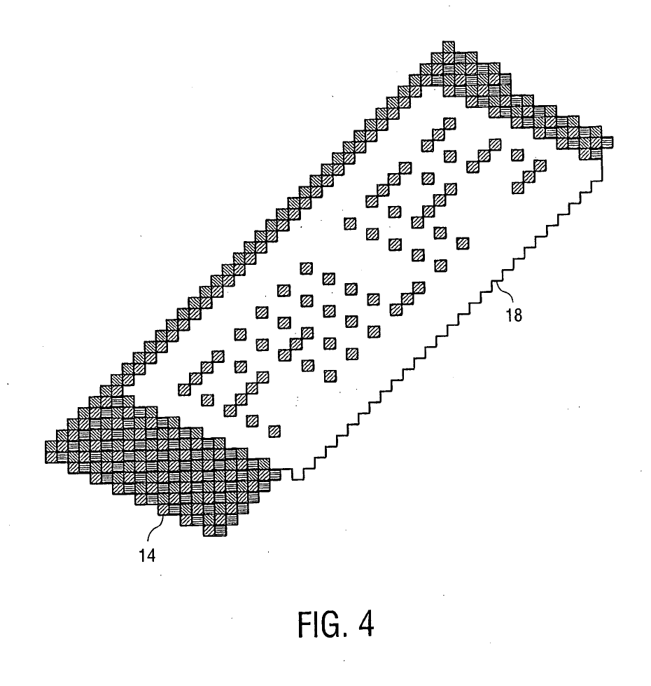

FIG. 4 shows an example of a monochromic image written on a record carrier according to the present invention. In this example, a white mask layer 18 is used that covers most of the pixels of the colored pixel pattern layer 14. The apertures in the mask layer 18 are chosen so that only green pixels of the colored pixel pattern layer 14 are visible. Thus, a monochromic image is created. By an appropriate selection of the apertures, colored images can be created.

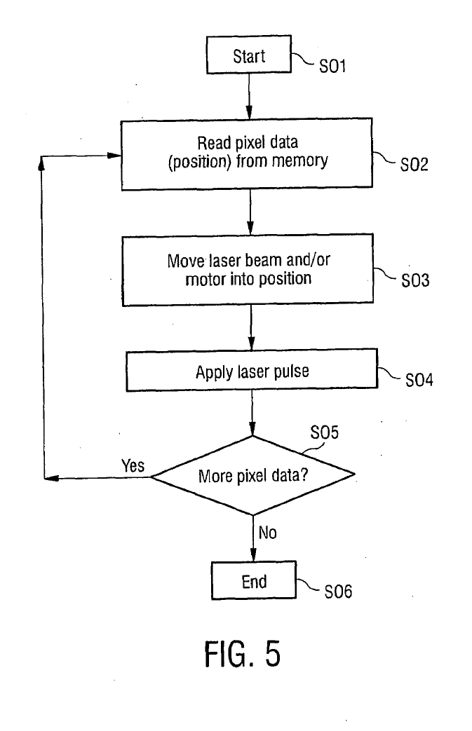

FIG. 5 shows a flow chart illustrating a preferred embodiment of a method according to the present invention. After the start of the recording procedure in step S01, pixel data, i.e. the positions of the apertures to be applied, are read from a memory in step S02. Consequently, the laser beam and/or the motor move into a position so that the desired location of the record carrier can be reached by the laser beam in step S03. In step S04 a laser pulse is applied. Thereby, an aperture in the mask layer is generated. In step S05 it is judged whether more pixel data are to be processed. If not, the recording procedure ends at step S06. If yes, the next pixel data are read in step S02.

It is noted that the system and the method according to the present invention can be different from the examples shown in the drawings and described above. For example, more than one laser can be supplied within the system so that the different needs of reading and writing data and of recording an image to the record carrier can be optimized with respect to the properties of the laser. Furthermore, the present invention is not limited to an application related to optical recording in the sense of CD, DVD, etc. The record carrier according to the present invention can be any suitable object on which an image is to be recorded. Thus, the present invention provides, on the one hand, an improvement of optical recording by providing a desirable labeling strategy, and, on the other hand, a basic printing concept.

Equivalents and modifications not described above may also be employed without departing from the scope of the invention, which is defined in the accompanying claims.

1. A record carrier (10) having a plurality of stacked layers (12, 14, 16, 18) comprising at least one colored pixel pattern layer (14) and at least one mask layer (18) on top of at least a region of the colored pixel pattern layer, the optical transparency of a region of the mask layer changing by applying heat by a laser beam (24) to the region of the mask layer, characterized in that at least one thermal barrier layer (16) is provided between the colored pixel pattern layer and the mask layer.

2. The record carrier according to claim 1, wherein the plurality of stacked layers (12, 14, 16, 18) comprises a substrate (12) on top of which the colored pixel pattern layer (14), the thermal barrier layer (16) and the mask layer (18) are arranged, and wherein the substrate (12) comprises grooves for tracking purposes.

3. The record carrier according to claim 1, wherein the colored pixels are at least partly aligned with the grooves.

4. The record carrier according to claim 1, wherein calibration apertures are provided in the mask layer.

5. The record carrier according to claim 1, wherein the sequence of layers is (a) substrate, (b) colored pixel pattern layer, (c) thermal barrier layer, and (d) mask layer.

6. The record carrier according to claim 1, wherein the sequence of layers is (a) substrate, (b) mask layer, (c) thermal barrier layer, and (d) colored pixel pattern layer.

7. The record carrier according to claim 1, wherein the thermal barrier layer (16) comprises a material from the group of ZnS-SiO₂, SiC, Si₃N₄, Al₂O₃.

8. The record carrier according to claim 1, wherein the mask layer (18) comprises a thermo-chromic material.

9. The record carrier according to claim 8, wherein the mask layer (18) comprises a material from the group of AgO and poly(3,4-ethylenedioxythiophene).

10. The record carrier according to claim 1, wherein the mask layer (18) comprises organic dyes.

11. The record carrier according to claim 1, wherein the mask layer (18) comprises a material that undergoes a phase transition upon heating.

12. The record carrier according to claim 1, wherein the mask layer comprises a dual layer system that mixes upon heating, thereby changing the transparency.

13. A method of recording an image on a record carrier (10), the record carrier having a plurality of stacked layers (12, 14, 16, 18) comprising at least one colored pixel pattern layer (14) and at least one mask layer (18) on top of at least a region of the colored pixel pattern layer, the optical transparency of a region of the mask layer changing by applying heat by a laser beam to the region of the mask layer, characterized in that at least one thermal barrier layer (16) is provided between the colored pixel pattern layer and the mask layer.

14. The method according to claim 13, wherein a defocused laser beam provided in an optical recorder is used.

15. An optical recorder for recording an image on a record carrier according to claim 1.
